(19) United States
(12) Patent Application Publication
(10) Pub. No.: US 2014/0203900 A1
(43) Pub. Date: Jul. 24, 2014

(54) COMMON MODE FILTER AND METHOD OF MANUFACTURING THE SAME

(71) Applicant: SAMSUNG ELECTRO-MECHANICS CO., LTD., Suwon-si (KR)

(72) Inventors: Jun Hee BAE, Suwon-si (KR); Sang Moon LEE, Suwon-si (KR); Jeong Bok KWAK, Suwon-si (KR); Sung Kwon WI, Suwon-si (KR)

(73) Assignee: SAMSUNG ELECTRO-MECHANICS CO., LTD., Suwon-si (KR)

(21) Appl. No.: 14/158,650

(22) Filed: Jan. 17, 2014

(30) Foreign Application Priority Data
Jan. 22, 2013 (KR) 10-2013-0007024

(51) Int. Cl. H01F 17/04; H01F 41/12

(52) U.S. Cl. CPC H01F 17/04; H01F 41/12
USPC 336/177; 427/116

(57) ABSTRACT

Disclosed herein is a common mode filter including: a magnetic substrate; an electrode layer disposed on one surface of the magnetic substrate and formed of a coil electrode and an insulating resin enclosing the coil electrode; and an uneven layer disposed between the magnetic substrate and the electrode and formed of a groove and a projection, wherein a part of the insulating resin is depressed between the groove of the uneven layer, whereby an adhesion between the magnetic substrate and the insulating resin is increased.

### CROSS REFERENCE(S) TO RELATED APPLICATIONS

This application claims the benefit under 35 U.S.C. Section 119 of Korean Patent Application Ser. No. 10-2013-0007024 entitled “Common Mode Filter And Method Of Manufacturing The Same” filed on Jan. 22, 2013, which is hereby incorporated by reference in its entirety into this application.

### BACKGROUND OF THE INVENTION

1. Technical Field

The present invention relates to a common mode filter and a method of manufacturing the same, and more particularly, to a common mode filter having an uneven structure and a method of manufacturing the same.

2. Description of the Related Art

In accordance with the development of a technology, electronic devices such as a portable phone, a home appliance, a personal computer (PC), a personal digital assistant (PDA), a liquid crystal display (LCD), and the like, have been changed from an analog scheme into a digital scheme and have been speeded up due to an increase in a data amount to be processed. Therefore, USB 2.0, USB 3.0, and a high-definition multimedia interface (HDMI) have been widely distributed as a high speed transmission interface and used in numerous digital devices, such as a personal computer, a high quality digital television, and the like.

Unlike a single-end transmission system generally used for a long period of time, these interfaces adopt a differential signal system that uses a pair of signal lines to transmit a differential signal (differential mode signal). However, the digitized and speeded up electronic devices are sensitive to stimulus from the outside. That is, in the case in which small abnormal voltage and a high frequency noise are introduced from the outside into an internal circuit of the electronic device, a circuit may be damaged and a signal may be distorted.

In order to prevent a circuit breakage or a signal distortion of electronic devices from occurring, a filter is mounted to interrupt the introduction of abnormal voltage and high frequency noise into a circuit. Generally, a common mode filter has been used in a high speed differential signal line, and the like, to remove a common mode noise.

The common mode noise is noise occurring at the differential signal line and the common mode filter removes noises that may not be removed by the existing EMI filter. The common mode filter contributes to improvement in EMI characteristics of a home appliance, and the like, and improvement of antenna characteristics of a cellular phone, and the like.

Referring to Japanese Patent Laid-Open Publication No. 2012-015494, a general common mode filter according to the related art has a structure in which a magnetic substrate is disposed at a lower part and a plurality of coil electrodes are stacked thereon. Herein, an insulating resin is coated between the coil electrodes of each layer in order to impart electrical insulation and is also disposed between the coil electrode of a lowermost layer and the magnetic substrate.

According to the above structure, one surface of the magnetic substrate is bonded to an insulating resin. The magnetic substrate may be formed of Ni—Zn-based, Mn—Zn-based, Ni—Zn-based, Ni—Zn—Mg-based, Mn—Mg—Zn-based ferrite, or a mixture thereof, whereas the insulating resin is formed of polymer materials, such as epoxy resin, phenol resin, polyimide resin, and the like, to easily delaminate between the magnetic substrate and the insulating resin.

That is, when heterogeneous materials having different chemical properties are bonded to each other, an adhesion between the magnetic substrate and the insulating resin is reduced due to a difference in thermal residual stress occurring between the bonded boundary surface, such that the insulating resin may be separated from the magnetic substrate. As a result, moisture is permeated between the delaminated interfaces, such that the performance of the filter may be degraded.

### RELATED ART DOCUMENT

### Patent Document

(Patent Document 1) Patent Document: Japanese Patent Laid-Open Publication No. 2012-015494

### SUMMARY OF THE INVENTION

An object of the present invention is to provide a common mode filter including an uneven layer having an uneven structure between a magnetic substrate and an insulating substrate capable of improving reliability of products while preventing an adhesion between the magnetic substrate and the insulating resin from reducing and a method of manufacturing the same.

According to an exemplary embodiment of the present invention, there is provided a common mode filter, including: a magnetic substrate; an electrode layer disposed on one surface of the magnetic substrate and formed of a coil electrode and an insulating resin enclosing the coil electrode; and an uneven layer disposed between the magnetic substrate and the electrode and formed of a groove and a projection, wherein a part of the insulating resin is depressed between the groove of the uneven layer.

The uneven layer may be any one or two or more selected from Ni—Fe permalloy, pure iron, Fe—Cr stainless steel, Fe—Si alloy steel, Fe—Al alloy steel, and Fe—Si—Al alloy steel.

The magnetic substrate may be formed of a metal ferrite composite material and the uneven layer may be formed of a metal material.

The projection of the uneven layer may be formed in any one of a hexagonal shape, a cylindrical shape, and a polygonal cylindrical shape.

A width of a groove and a projection of the uneven layer may be set to be 1 to 5 μm.

A thickness of the uneven layer may be set to be 0.5 to 2 μm.

The coil electrode may be formed of a primary coil electrode and a secondary coil electrode that are electromagnetically coupled with each other.

The common mode filter may further include: external electrode terminals connected to both terminals of the coil electrode, respectively.

The common mode filter may further include: lower electrode terminals disposed on the electrode layer and connected to the external electrode terminals and a magnetic composite disposed between lower electrode terminals.

According to another exemplary embodiment of the present invention, there is provided a method of manufacturing a common mode filter, including: preparing a magnetic substrate; forming an unevenness layer formed of a groove and a projection on one surface of the magnetic substrate; applying an insulating resin to one surface of the magnetic substrate formed with the unevenness layer; and plating a coil electrode on the applied insulating resin and coating an insulating resin on the plated coil electrode.

The forming of the unevenness layer may include: attaching a mask provided with an opening part on one surface of the magnetic substrate; depositing metal on an area exposed through the opening part; and removing the mask.

In the depositing, any one of chemical vapor deposition (CVD), physical deposition (PVD), spin coating, dip coating, roll coating, screen coating, spray coating may be used.

At the plating of the coil electrode, external electrode terminals connected to both terminals of the coil electrode, respectively, may be plated together.

### BRIEF DESCRIPTION OF THE DRAWINGS

FIG. 1 is a perspective view of a common mode filter according to an exemplary embodiment of the present invention.

FIG. 2 is a cross-sectional view taken along the line I-I′ of FIG. 1.

FIG. 3 is a perspective view of a magnetic substrate included in the common mode filter according to the exemplary embodiment of the present invention.

FIGS. 4 to 9 are views sequentially illustrating processes of a method of manufacturing a common mode filter according to the exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

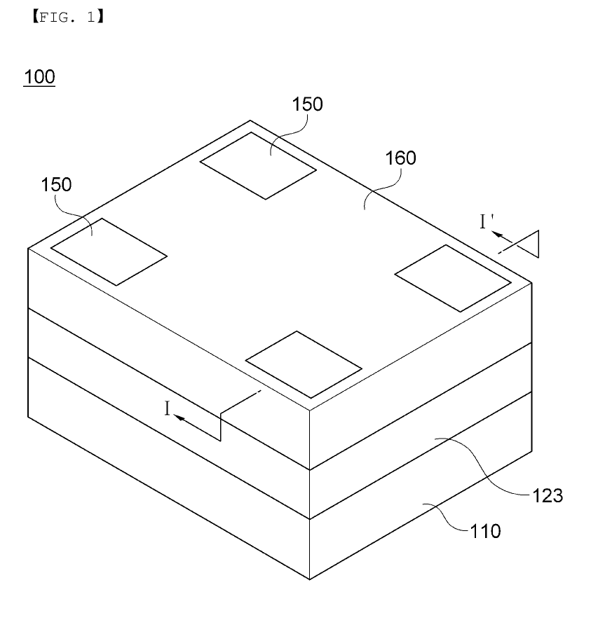

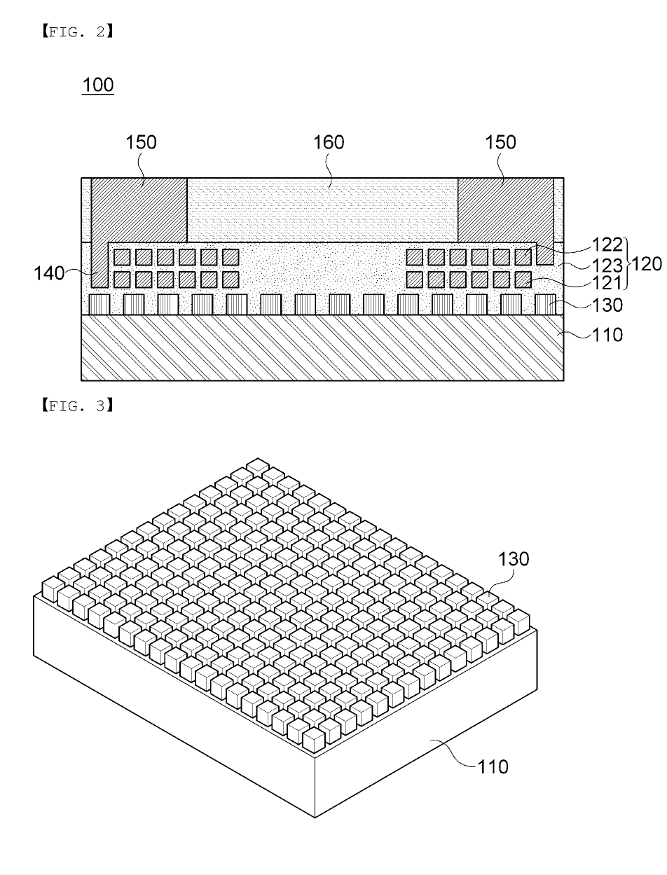

FIG. 1 is a perspective view of a common mode filter according to an exemplary embodiment of the present invention; and FIG. 2 is a cross-sectional view taken along the line I-I′ of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention. Meanwhile, throughout the accompanying drawings, the same reference numerals will be used to describe the same components. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

Referring to FIGS. 1 and 2, a common mode filter 100 according to an exemplary embodiment of the present invention may include a magnetic substrate 110, an electrode layer 120 formed on the magnetic substrate 110, and an uneven layer 130 disposed between the magnetic substrate 110 and the electrode layer 120.

The magnetic substrate 110 is a space that becomes a flux path and may be formed of Ni—Zn-based, Mn—Zn-based, Ni—Zn-based, Ni—Zn—Mg-based, Mn—Mg—Zn-based ferrite, or a mixture thereof having a high electric resistance and a small magnetic force loss so as to smooth a flow of flux and the foregoing materials may be mixed with one or more metal element of aluminum (Al), chromium (Cr), manganese (Mn), cobalt (Co), copper (Cu), zinc (Zn), niobium (Nb), molybdenum (Mo), indium (In), and tin (Sn) so as to increase permeability.

The electrode layer 120 may be configured of primary and secondary coil electrodes 121 and 122 that are electromagnetically coupled with each other and an insulating resin 123 enclosing the primary and secondary coil electrodes 121 and 122.

Construction materials of the insulating resin 123 may be appropriately selected in consideration of insulating property, thermal resistance, moisture resistance, and the like. For example, an example of the optimal polymer materials forming the insulating resin 123 may include thermosetting resin, such as epoxy resin, phenol resin, urethane resin, silicon resin, polyimide resin, and the like, and thermoplastic resin, such as polycarbonate resin, acrylic resin, polyacetal resin, polypropylene resin, and the like.

The primary and secondary coil electrodes 121 and 122 are electrodes plated on the same plane in a coil form and as illustrated in FIG. 2, the primary and secondary coil electrodes 121 and 122 are plated so as to be spaced apart from each other by a predetermined distance, having the insulating resin 123 therebetween or otherwise, the primary coil electrode 121 and the secondary coil electrode 122 may also be plated on the same layer so as to be alternately arranged to each other.

Both ends of the primary and secondary coil electrodes 121 and 122 are each connected to external electrode terminals 140 and the external electrode terminals 140 may be connected to lower electrode terminals 150 formed on the electrode layer 120. The lower electrode terminal 150, which is an electrode provided to mount a common mode filter element on a surface of a substrate, may be formed at a predetermined thickness and a magnetic composite 160 having the same thickness as the lower electrode terminal 150 may be formed on the electrode layer 120.

The uneven layer 130 disposed between the magnetic substrate 110 and the electrode layer 120 has an uneven structure in which grooves and projections are consecutively formed, such that a part of the insulating resin 123 forming the electrode layer 120 is depressed between the grooves of the uneven layer 130.

Here, the uneven layer 130 is made of a metal material and chemically stably coupled with a metal material included in the magnetic substrate 110, such that the magnetic substrate 110 and the uneven layer 130 are integrated enough to make it difficult to differentiate a boundary therebetween.

As a result, a bonding area of the insulating resin 123 is increased due to the uneven structure of the uneven layer 130, such that the adhesion between the magnetic substrate 110 and the insulating resin 123 may be reinforced.

In order to flow a flux more smoothly, the uneven layer 130 may be made of NI-Fe permalloy having high permeability among the metal materials and may be made of one or more material selected from a group consisting of pure iron, Fe—Cr stainless steel, Fe—Si alloy steel, Fe—Al alloy steel, and Fe—Si—Al alloy steel, including the foregoing material.

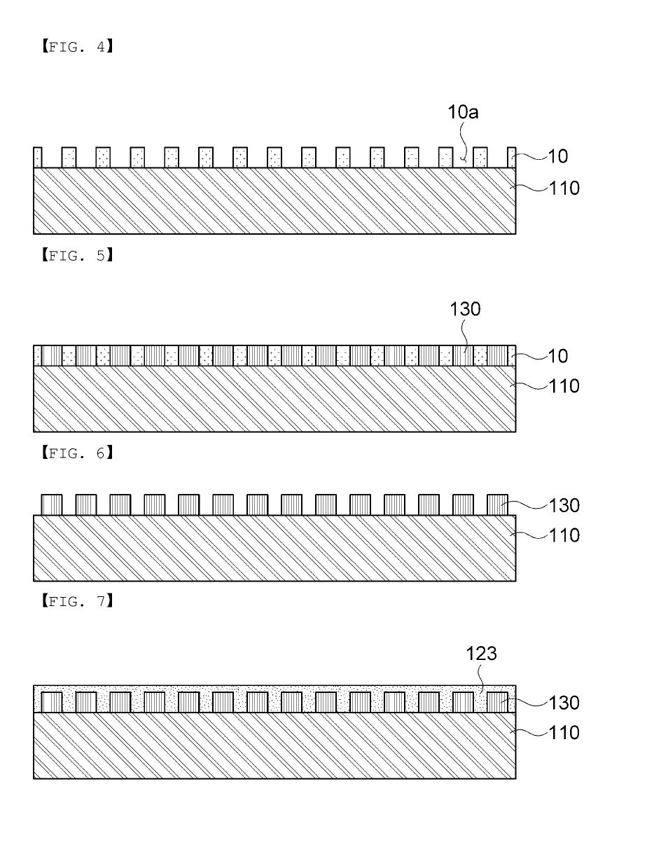

FIG. 3 is a perspective view of the magnetic substrate 110 to which the uneven layer 130 is bonded and as illustrated in FIG. 3, the projections of the uneven layer 130 may have a hexagonal shape and may be formed in various shapes such as a cylinder, a polygon, and the like, according to a shape of an opening part used during the manufacturing process, including the foregoing shape.

In this case, a width of the groove and the projection of the uneven layer 130 may be set to be 1 to 5 μm and a thickness of the uneven layer 130 may be set to be 0.5 to 2 μm. As the width of the groove and the projection of the uneven layer 130 is narrow, that is, the unevenness is densely formed, the bonding area of the insulating resin 123 is increased to reinforce the adhesion with the magnetic substrate 110. However, when the unevenness is excessively densely formed, the groove and the projection are difficult to manufacture and also to depress the insulating resin 123 between the grooves.

Similarly, the thicker the thickness of the uneven layer 130 is, the more the bonding area of the insulating resin 123 has, but when the thickness of the uneven layer 130 is excessively thick, it is difficult to depress the insulating resin 123 up to the bottom of the groove, such that the width of the groove and the projection of the uneven groove 130 and the thickness of the uneven layer 130 may be set to be an appropriate value within a numerical range. However, the numerical range is defined as an optimal value that maximally exhibits an effect within a range without departing from the object of the present invention and if the numerical value meets the object of the present invention, it is apparent to those skilled in the art that the numerical range that slightly deviates from the optimal value may be permitted.

A method of manufacturing a common mode filter according to an exemplary embodiment of the present invention will be described below.

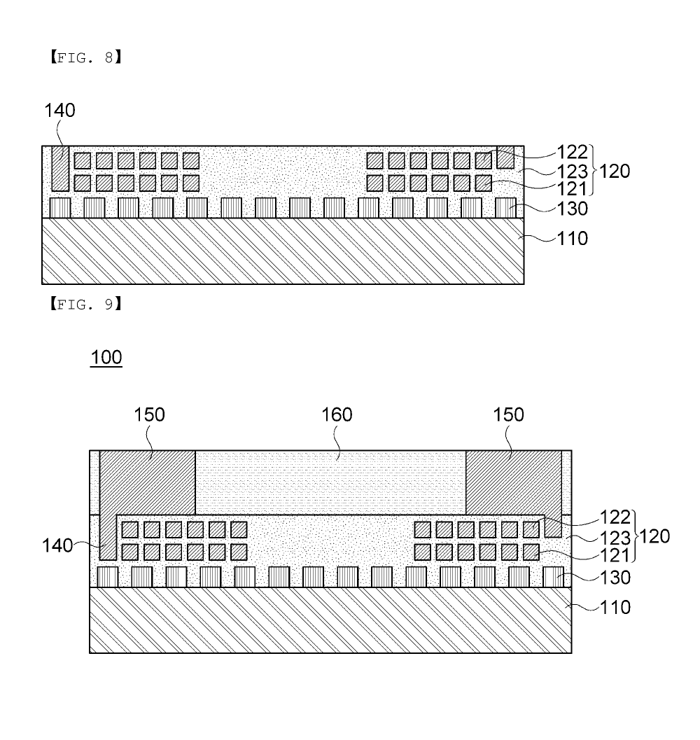

FIGS. 4 to 9 are views sequentially illustrating processes of a method of manufacturing a common mode filter according to the exemplary embodiment of the present invention. The method for manufacturing a common mode filter according to the exemplary embodiment of the present invention includes preparing the magnetic substrate 110 and forming the uneven layer 130 having the uneven structure on one surface of the prepared magnetic substrate 110.

Describing in more detail the process of forming the uneven layer 130, as illustrated in FIG. 4, a mask 10 provided with an opening part 10a is first attached to one surface of the magnetic substrate 110.

The uneven layer 130 is formed on an area exposed through the opening part 10a, such that the opening part 10a may be prepared in a pattern corresponding to the uneven structure of the uneven layer 130. That is, as illustrated in FIG. 5, when metal is deposited on the area exposed through the opening part 10a using a generally known deposition technology, metal is deposited at a desired thickness, and the mask 10 is removed as illustrated in FIG. 6, an area covered with the mask 10 becomes the groove of the uneven layer 130 and the deposited metal becomes a projection of the uneven layer 130.

Herein, as the deposition technology, generally known technologies, such as chemical vapor deposition (CVD), physical deposition (PVD), spin coating, dip coating, roll coating, screen coating, spray coating, and the like, may be used.

As such, a pattern structure of the uneven layer 130 is formed corresponding to the pattern of the opening part 10a, such that the width of the opening part 10a and an interval between the opening parts 10a are set corresponding to the width of the groove and the projection of the uneven layer 130 and as described above, the values thereof may be set to be 1 to 5 μm.

Similarly, the thickness of the uneven layer 130 is determined by the thickness of the mask 10, and therefore the thickness of the mask 10 is set to be 0.5 to 2 μm.

When the uneven layer 130 is completed, as illustrated in FIG. 7, the insulating resin 123 is applied to one surface of the magnetic substrate 110, on which the uneven layer 130 is formed, at a predetermined thickness.

The application of the insulating resin 123 may be performed by using a spin coating method, a tape casting method, and the like, and a part of the applied insulating resin 123 is depressed into the groove of the uneven layer 130.

Next, a plating process and a coating process are repeatedly performed on an upper surface of the applied insulating resin 123 to complete the primary and secondary coil electrodes 121 and 122 and the electrode layer 120 formed of the insulating resin 123 enclosing the primary and secondary coil electrodes 121 and 122, as illustrated in FIG. 8. Further, for describing only the characteristic parts of the present invention, the detailed description is omitted, but at the time of the plating process, the external electrode terminals 140, connected to both terminals of the primary and secondary coil electrodes 121 and 122, respectively, may be plated together.

Finally, as illustrate in FIG. 9, when the electrode layer 120 is completed, the lower electrode terminal 150 bonded to the external electrode terminal 140 is formed on the electrode layer 120 and a magnetic paste is filled between the lower electrode terminal 150 and cured, thereby finally completing the common mode filter 100 according to the present invention in which the magnetic composite 160 is formed.

According to the exemplary embodiments of the present invention, the uneven layer having the uneven structure can be disposed between the magnetic substrate and the insulating resin to increase the bonding area of the insulating resin, thereby greatly improving the adhesion between the magnetic substrate and the insulating resin and the uneven layer can be formed of permalloy having high permeability, and the like, to more improve the performance of the common mode filter.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A common mode filter, comprising:
a magnetic substrate;
an electrode layer disposed on one surface of the magnetic substrate and formed of a coil electrode and an insulating resin enclosing the coil electrode; and
an uneven layer disposed between the magnetic substrate and the electrode and formed of a groove and a projection,
wherein a part of the insulating resin is depressed between the groove of the uneven layer.

2. The common mode filter according to claim 1, wherein the uneven layer is any one or two or more mixture selected from Ni—Fe permalloy, pure iron, Fe—Cr stainless steel, Fe—Si alloy steel, Fe—Al alloy steel, and Fe—Si—Al alloy steel.

3. The common mode filter according to claim 1, wherein the magnetic substrate is made of a metal ferrite composite material and the uneven layer is made of a metal material.

4. The common mode filter according to claim 1, wherein the projection of the uneven layer is formed in any one of a hexagonal shape, a cylindrical shape, and a polygonal cylindrical shape.

5. The common mode filter according to claim 1, wherein a width of a groove and a projection of the uneven layer is set to be 1 to 5 μm.

6. The common mode filter according to claim 1, wherein a thickness of the uneven layer is set to be 0.5 to 2 μm.

7. The common mode filter according to claim 1, wherein the coil electrode is formed of a primary coil electrode and a secondary coil electrode that are electromagnetically coupled with each other.

8. The common mode filter according to claim 1, further comprising:
external electrode terminals connected to both terminals of the coil electrode, respectively.

9. The common mode filter according to claim 8, further comprising:
lower electrode terminals disposed on the electrode layer and connected to the external electrode terminals and a magnetic composite disposed between lower electrode terminals.

10. A method of manufacturing a common mode filter, comprising:
preparing a magnetic substrate;
forming an unevenness layer formed of a groove and a projection on one surface of the magnetic substrate;
applying an insulating resin to one surface of the magnetic substrate formed with the unevenness layer; and
plating a coil electrode on the applied insulating resin and coating an insulating resin on the plated coil electrode.

11. The method according to claim 10, wherein the forming of the unevenness layer includes:
attaching a mask provided with an opening part on one surface of the magnetic substrate;
depositing metal on an area exposed through the opening part; and
removing the mask.

12. The method according to claim 11, wherein in the depositing, any one of chemical vapor deposition (CVD), physical deposition (PVD), spin coating, dip coating, roll coating, screen coating, spray coating is used.

13. The method according to claim 10, wherein at the plating of the coil electrode, external electrode terminals connected to both terminals of the coil electrode, respectively, are plated together.
